(19) United States
(12) Patent Application Publication
(10) Pub. No.: US 2025/0029258 A1
(43) Pub. Date: Jan. 23, 2025

(54) NOISE REMOVAL METHOD AND COMPUTER PROGRAM RECORDED ON RECORD-MEDIUM TO EXECUTE THE SAME

(71) Applicant: MOBILTECH, Seoul (KR)

(72) Inventors: Jae Seung KIM, Seoul (KR); Man Gyu KIM, Anyang-si (KR)

(21) Appl. No.: 18/746,825

(22) Filed: Jun. 18, 2024

(30) Foreign Application Priority Data
Jul. 21, 2023 (KR) 10-2023-0095434

(51) Int. Cl. G06T 7/11; G06T 5/70; G06T 7/521

(52) U.S. Cl. CPC G06T 7/11; G06T 5/70; G06T 7/521; G06T 2207/10028

(57) ABSTRACT

A noise removal method may include receiving, by a data processing device, point cloud data acquired from a LiDAR and an image captured by a camera, identifying, by the data processing device, a preset object from the image, deleting, by the data processing device, a point cloud corresponding to the object identified from the image from the point cloud data, and generating, by the data processing device, a map based on point cloud data from which the point cloud corresponding to the object was deleted. The present method is technology developed and supported by the Ministry of Trade, Industry and Energy/Korea Planning & Evaluation Institute of Industrial Technology (Task No. 20017992/Project Name-Excellent Company Research Institute Development Project (ATC+)/Task Name-Development of Real-time risk detection and map generating solution based on 3D scanning technology to ensure safety during autonomous driving).

### CROSS REFERENCE TO RELATED APPLICATION

This application claims priority from Republic of Korea Patent Application No. 10-2023-0095434, filed on Jul. 21, 2023, which is hereby incorporated by reference in its entirety.

### BACKGROUND

### Field

The present disclosure relates to noise removal, and more particularly, to a noise removal method for removing noise caused by a dynamic object in the process of acquiring data to generate a map, and a computer program recorded on a recording medium to execute the same.

### Related Art

Autonomous driving of a vehicle refers to a system that allows the vehicle to determine and drive on its own. As such, autonomous driving may be divided into progressive stages from non-automation to full automation depending on the degree to which the system participates in driving and the degree to which a driver controls the vehicle. In general, the stages of autonomous driving are divided into six levels classified by SAE (Society of Automotive Engineers) International. According to the six levels classified by the International Association of Automotive Engineers, level 0 is non-automation, level 1 is driver assistance, level 2 is partial automation, level 3 is conditional automation, level 4 is high automation, and level 5 is full automation.

Autonomous driving is performed through mechanisms of perception, localization, path planning, and control. In addition, various companies are developing to implement perception and path planning in autonomous driving mechanisms using artificial intelligence (AI).

For autonomous driving, various information on the road should be collected preemptively. However, in reality, it is not easy to collect and analyze massive amounts of information in real time using only sensors of vehicles. Accordingly, in order for autonomous driving to become a reality, a high-precision road map that may provide various information necessary for actual autonomous driving is essential.

Here, the high-precision road map refers to a three-dimensional electronic map constructed with information on roads and surrounding terrain with an accuracy of ±25 cm. The high-precision road map includes precision information, such as a road width, a road curvature, a road slope, lane information (dotted lines, solid lines, stop lines, etc.), surface type information (crosswalks, speed bumps, shoulders, etc.), road mark information, sign information, and facility information (traffic lights, curbs, manholes, etc.), in addition to general electronic map information (node information and link information required for route guidance).

In order to create a road map with such precision, various related data, such as mobile mapping system (MMS) and aerial photography information are required.

In particular, the MMS is mounted on a vehicle and is used to measure locations of geographic features in the vicinity of the road and acquire visual information while driving the vehicle. In other words, the MMS may be generated based on information collected by the GPS, inertial navigation system (INS), and inertial measurement unit (IMU) for collecting the location of a vehicle body and attitude information, cameras and light detection and ranging (LiDAR) for collecting the shape and information of geographic features, and other sensors.

As such, the high-precision road map includes various objects, such as buildings, facilities, and roads. Here, information on buildings or roads included in the high-precision road map is not often added or deleted, but facilities are frequently added or deleted in many cases.

Accordingly, recently, there is a need for a method to identify and manage the status of facilities on a high-precision road map with high accuracy and to update a stored map according to the status of the facilities.

In addition, images collected in the process of generating a high-precision road map include not only static objects, such as buildings, facilities, and roads, but also dynamic objects, such as vehicles. Here, the dynamic objects correspond to noise in the high-precision road map. Therefore, there is a need for a method that may remove noise, such as dynamic objects, on the high-precision road map.

Meanwhile, an artificial intelligence (AI) model for identifying objects in images to determine a status of facilities had a problem of essentially requiring expensive devices, such as a graphics processing unit (GPU).

The present disclosure is technology developed and supported by the Ministry of Trade, Industry and Energy/Korea Planning & Evaluation Institute of Industrial Technology (Task No. 20017992/Project Name-Excellent Company Research Institute Development Project (ATC+)/Task Name-Development of Real-time risk detection and map generating solution based on 3D scanning technology to ensure safety during autonomous driving).

### RELATED ART DOCUMENT

### Patent Document

(Patent Document 0001) Korean Patent No. 10-2283868, ‘Road precision map production system for autonomous driving’, (registered on Jul. 26, 2021)

### SUMMARY

The present disclosure provides a noise removal method for removing noise caused by a dynamic object in the process of acquiring data to generate a map.

The present disclosure also provides a computer program recorded on a recording medium to execute a noise removal method for removing noise caused by a dynamic object in the process of acquiring data to generate a map.

The technical problems of the present disclosure are not limited to the technical problems mentioned above, and other technical problems not mentioned will be clearly understood by those skilled in the art from the description below.

In an aspect, a noise removal method for removing noise caused by a dynamic object in the process of acquiring data to generate a map is proposed. The method includes receiving, by a data processing device, point cloud data acquired from a LiDAR and an image captured by a camera, identifying, by the data processing device, a preset object from the image, deleting, by the data processing device, a point cloud corresponding to the object identified from the image from the point cloud data, and generating, by the data processing device, a map based on point cloud data from which the point cloud corresponding to the object was deleted.

In the receiving of the image, whether data of the image previously existed through a dictionary-type compression algorithm may be determined to indicate whether the data is repetitive, the image may be encoded, and the image may be compressed by assigning different prefix codes according to a frequency of appearance of characters included in the image.

In the identifying of the object, a preset object in the image may be identified through segmentation based on artificial intelligence (AI) that has been previously machine-trained.

In the identifying of the object, a bounding box may be designated in a region corresponding to the preset object in the image.

In the identifying of the object, semantic segmentation may be performed on the image based on artificial intelligence that has been machine-trained in advance based on data corresponding to the object.

In the identifying of the object, time stamps for images continuously received by the camera may be recorded, the continuously received images may be sorted based on the recorded time stamps, and the object may be identified based on a similarity between neighboring images among the sorted images.

In the deleting, an object moving within the image may be identified based on the amount of change in RGB (red, green, and blue) between neighboring images.

In the deleting, calibration may be performed on the image and the point cloud data, and a point cloud at the same coordinates as the object identified on the image may be deleted.

In the deleting, group point clouds included in the object identified on the image may be grouped into a plurality of unit point clouds based on distance values from the LiDAR, a unit point cloud in which a distance value from the LiDAR among the plurality of unit point clouds is the shortest may be identified as a point cloud corresponding to the object and deleted.

In the deleting, an outlier among point clouds included in the object identified on the image

may be identified based on a density and point clouds excluding the identified outlier may be deleted.

In the deleting, at least one object may be identified based on a density within the point cloud data acquired from the LiDAR, and a point cloud included in an object in which an amount of change in distance, among the at least one identified object, exceeds a preset value may be additionally deleted.

In the deleting, the point cloud corresponding to the identified object may be deleted on a map pre-generated based on the point cloud data acquired from the LiDAR and the image captured by the camera.

In another aspect, a computer program recorded on a recording medium to execute the above method is proposed. The computer program may be combined with a computing device including a memory, a transceiver, and a processor processing an instruction loaded in the memory. Also, the computer program may be recorded in a recording medium to execute receiving, by the processor, point cloud data acquired from a LiDAR and an image captured by a camera, identifying, by the processor, a preset object from the image, deleting, by the processor, a point cloud corresponding to the object identified from the image from the point cloud data, and generating, by the processor, a map based on point cloud data from which the point cloud corresponding to the object was deleted.

Specific details of other embodiments are included in the detailed description and drawings.

According to embodiments of the present disclosure, an object corresponding to a dynamic object may be identified in an image for generating a map, and a map is generated with the identified object deleted, thereby removing noise caused by a dynamic object in the process of acquiring data to create a map.

The effects of the present disclosure are not limited to the effects mentioned above, and other effects not mentioned may be clearly understood by those skilled in the art from the description of the claims.

### BRIEF DESCRIPTION OF THE DRAWINGS

FIG. 1 is a configuration diagram of a data generating system according to an embodiment of the present disclosure.

FIG. 2 is a logical configuration diagram of a data processing device according to an embodiment of the present disclosure.

FIG. 3 is a hardware configuration diagram of a data processing device according to an embodiment of the present disclosure.

FIG. 4 is a flowchart illustrating a facility updating method according to an embodiment of the present disclosure.

FIG. 5 is a flowchart illustrating a facility management method according to an embodiment of the present disclosure.

FIG. 6 is a flowchart illustrating a facility management method according to another embodiment of the present disclosure.

FIG. 7 is a flowchart illustrating a noise removal method according to an embodiment of the present disclosure.

FIG. 8 is a flowchart illustrating an artificial intelligent model lightweighting method according to an embodiment of the present disclosure.

FIGS. 9 to 11 are diagrams illustrating a facility updating method according to an embodiment of the present disclosure.

FIGS. 12 to 14 are diagrams illustrating a facility management method according to an embodiment of the present disclosure.

FIGS. 15 and 16 are diagrams illustrating a facility management method according to another embodiment of the present disclosure.

FIGS. 17 and 18 are diagrams illustrating a noise removal method according to an embodiment of the present disclosure.

### DESCRIPTION OF EXEMPLARY EMBODIMENTS

Technical terms used in this specification are used to merely illustrate specific embodiments, and should be understood that they are not intended to limit the present disclosure. As far as not being defined differently, all terms used herein including technical or scientific terms may have the same meaning as those generally understood by an ordinary person skilled in the art to which the present disclosure belongs to, and should not be construed in an excessively comprehensive meaning or an excessively restricted meaning. In addition, if a technical term used in the description of the present disclosure is an erroneous term that fails to clearly express the idea of the present disclosure, it should be replaced by a technical term that may be properly understood by the skilled person in the art. In addition, general terms used in the description of the present disclosure should be construed according to definitions in dictionaries or according to its front or rear context, and should not be construed to have an excessively restrained meaning.

The singular expression used in the present specification includes the plural expression unless the context clearly indicates otherwise. In the specification, it is to be noted that the terms “comprising” or “including”, and the like, are not be construed as necessarily including several components or several steps described in the specification and some of the above components or steps may not be included or additional components or steps are construed as being further included.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure.

It will be understood that when an element is referred to as being “connected with” another element, the element may be directly connected with the other element or intervening elements may also be present. In contrast, when an element is referred to as being “directly connected with” another element, there are no intervening elements present.

Embodiments of the present disclosure will be described below in detail with reference to the accompanying drawings where those components are rendered the same reference number that are the same or are in correspondence, regardless of the figure number, and redundant explanations are omitted. In describing the present disclosure, if a detailed explanation for a related known function or construction is considered to unnecessarily divert the gist of the present disclosure, such explanation has been omitted but would be understood by those skilled in the art. The accompanying drawings are used to help easily understood the technical idea of the present disclosure and it should be understood that the idea of the present disclosure is not limited by the accompanying drawings. The idea of the present disclosure should be construed to extend to any alterations, equivalents and substitutes besides the accompanying drawings.

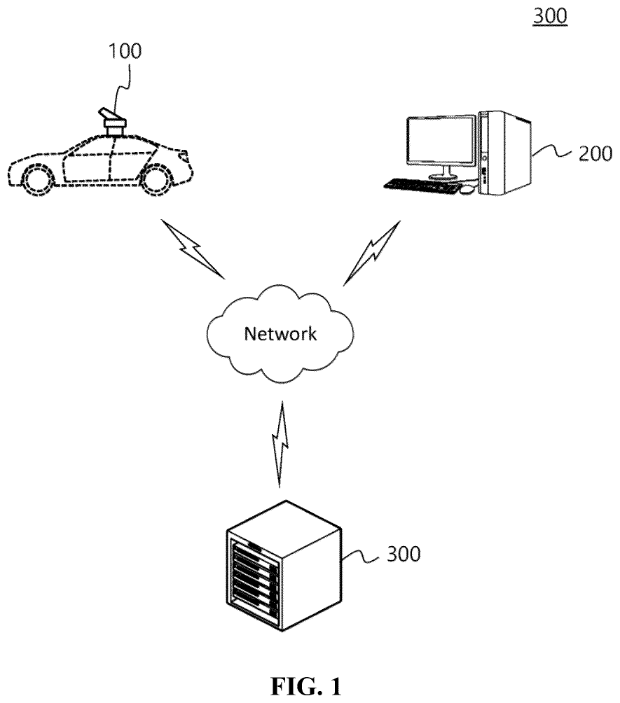

FIG. 1 is a configuration diagram of a data generating system according to an embodiment of the present disclosure.

Referring to FIG. 1, a data generating system according to an embodiment of the present disclosure may include a data collecting device 100, a data generating device 200, and a data processing device 300.

The components of the data generating system according to the present embodiment merely represent functionally distinct elements, so two or more components may be integrated to be implemented in an actual physical environment or one component may be separated to be implemented in an actual physical environment.

To describe each component, the data collecting device 100 may be mounted on a vehicle and collect data for generating a map or training a learning model for generating a map.

The data collecting device 100 may be configured to include one or more of LiDAR, a camera, a radar, an IMU, and a GPS. However, the data collecting device 100 is not limited thereto, and sensors capable of sensing various information may be applied to generate a map.

That is, the data collecting device 100 may acquire point cloud data from a LiDAR and acquire images captured by a camera. In addition, the data collecting device 100 may acquire information related to a location and a pose from an IMU, GPS, etc.

Here, the LiDAR may fire laser pulses around a vehicle and detect light reflected by objects located around the vehicle, thereby generating point cloud data corresponding to a 3D image around the vehicle.

The camera may acquire images of a space collected from the LiDAR based on the LiDAR. The camera may include any one of a color camera, a near infrared (NIR) camera, a short wavelength infrared (SWIR) camera, and a long wavelength infrared (LWIR) camera.

The IMUs may include an acceleration sensor and an angular velocity sensor (gyroscope), and some may also include a magnetometer and may measure a change in acceleration according to a change in the movement of the data collecting device 100.

The GPS may receive signals transmitted from artificial satellites and measure the location of the data collecting device 100 using triangulation.

This data collecting device 100 may be installed on a vehicle or an aerial device. For example, the data collecting device 100 may be installed on top of a vehicle to collect surrounding point cloud data or an image or installed at the bottom of an aerial device to collect point cloud data or an image of an object on the ground from the air.

In addition, the data collecting device 100 may transmit the collected point cloud data or images to the data generating device 200.

As a next component, the data generating device 200 may receive the point cloud data acquired by the LiDAR and the image captured by the camera from the data collecting device 100.

The data generating device 200 may generate a map based on the point cloud data and the image received from the data collecting device 100.

Specifically, the data generating device 200 may perform calibration of the point cloud data and the image to place the point cloud data on a world coordinate system and grant the color of pixels of the image corresponding to the coordinates of each placed point.

The data generating device 200, which has the above characteristics, may be any device that may transmit and receive data to and from the data collecting device 100 and the data processing device 300 and perform calculation based on the transmitted and received data. For example, the data generating device 200 may be any one of fixed computing devices, such as a desktop, a workstation, or a server, but is not limited thereto.

As a next component, the data processing device 300 may process the map generated by the data generating device 200.

Meanwhile, the data generating device 200 and the data processing device 300 are described as separate components, but in an actual physical environment, they may be integrated with each other to be implemented.

Characteristically, according to an embodiment of the present disclosure, the data processing device 300 may receive the point cloud data acquired from a LiDAR installed on a vehicle traveling on a path of a pre-stored reference map and the image captured through a camera and identify an object corresponding to a facility based on the received point cloud data and the image. In addition, the data processing device 300 may update object information on the reference map by matching the identified object with the reference map.

According to another embodiment of the present disclosure, the data processing device 300 may receive the point cloud data acquired from the LiDAR and the image captured by the camera, identify a preset object from the image, and delete a point data corresponding to the identified object from the image from the point cloud data. In addition, the data processing device 300 may generate a map based on the point cloud data from which the point cloud corresponding to the object has been deleted.

According to another embodiment of the present disclosure, the data processing device 300 may identify an object corresponding to a preset facility on the image captured by the camera and process the image for the identified object. In addition, the data processing device 300 may determine whether the object corresponding to the processed image is damaged.

According to another embodiment of the present disclosure, the data processing device 300 may perform pruning on an artificial intelligence (AI) model machine-trained by a first data set and quantize the AI model on which the pruning has been performed. In addition, the data processing device 300 may train the AI model by imitating another AI model pre-trained with a second data set including a larger amount of data than the first data set.

According to another embodiment of the present disclosure, the data processing device 300 may identify an object corresponding to a preset facility on the image captured by the camera and recognize text included in the identified object. In addition, the data processing device 300 may identify the type of facility corresponding to the identified object based on the recognized text.

Meanwhile, various embodiments of the present disclosure are described as performing separate functions, but the present disclosure is not limited thereto and may be applied by combining the functions of each other.

The data processing device 300, which has the above characteristics, may be any device that may transmit and receive data to and from the data collecting device 100 and the data generating device 200 and perform calculation based on the transmitted and received data. For example, the data processing device 300 may be any one of fixed computing devices, such as a desktop, a workstation, or a server, but is not limited thereto.

The data collecting device 100, the data generating device 200, and the data processing device 300 described above may transmit and receive data using a combination of one or more of a security line, a public wired communication network, or a mobile communication network that directly connect the devices.

For example, the public wired communication network may include Ethernet, x digital subscriber line (xDSL), hybrid fiber coax (HFC), and fiber to the home (FTTH) but is not limited thereto. In addition, the mobile communication network may include code division multiple access (CDMA), wideband CDMA (WCDMA), high speed packet access (HSPA), long term evolution (LTE), and 5th generation mobile telecommunication but is not limited thereto.

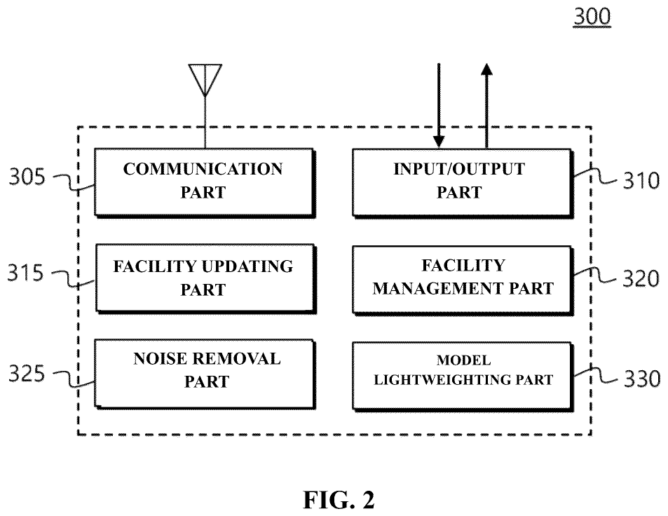

FIG. 2 is a logical configuration diagram of the data processing device according to an embodiment of the present disclosure.

Referring to FIG. 2, the data processing device 300 according to an embodiment of the present disclosure may include a communication part 305, an input/output part 310, a facility updating part 315, a facility management part 320, a noise removal part 325, and a model lightweighting part 330.

Since the components of the data processing device 300 merely represent functionally distinct elements, two or more components may be integrated to be implemented in the actual physical environment or one component may be separated to be implemented in the actual physical environment.

To describe each component, the communication part 305 may transmit and receive data to and from the data collecting device 100 and the data generating device 200. Specifically, the communication part 305 may receive point cloud data acquired by the LiDAR and images captured through the camera from the data collecting device 100 or the data generating device 200. In addition, the communication part 305 may receive the generated map from the data generating device 200 and may receive a learning model generated for object detection.

As a next component, the input/output part 310 may receive signals from a user through a user interface (UI) or output calculation results to the outside. Specifically, the input/output part 310 may output facility status information, an updated map, etc.

As a next component, the facility updating part 315 may acquire a facility status for a driving section from the camera mounted on the vehicle traveling on the route on the map and update the facility on the map according to the facility status. For example, the facility may include a sign, a traffic light, etc. that exist adjacent to the road.

To this end, the facility updating part 315 may receive point cloud data acquired from the LiDAR installed on the vehicle traveling on the route on the reference map and the image simultaneously captured through the camera.

Next, the facility updating part 315 may identify an object corresponding to the facility based on the received image.

Specifically, the facility updating part 315 may set a bounding box for a region corresponding to the object in the received image. At this time, the facility updating part 315 may set the bounding box for the region corresponding to the object in the received image based on artificial intelligence (AI) that has been machine-trained in advance based on a pre-stored object model.

Here, the bounding box is a region for specifying an object corresponding to a facility among the objects included in the image. As such, the bounding box may have a rectangle or polygon shape, but is not limited thereto.

Next, the facility updating part 315 may collect point clouds included in the bounding box by projecting the point cloud data onto the image. That is, the facility updating part 315 may collect points included in the bounding box by projecting the point cloud data acquired from the LiDAR through calibration of the camera and the LiDAR onto the image. At this time, the facility updating part 315 may accumulate and store the points included in the bounding box for a plurality of images that are continuously received.

In addition, the facility updating part 315 may classify the collected point clouds and perform clustering in units of objects. That is, the facility updating part 315 may cluster the collected point clouds in units of objects based on point attributes including one of GPS coordinates, density, and a class name.

Meanwhile, before performing clustering, the facility updating part 315 may sort the point groups included in the bounding box based on a distance value from the LIDAR and filter noise points based on the density of the sorted points. That is, the facility updating part 315 may classify the point cloud corresponding to the actual object based on the density of the points included in the bounding box, determine the remaining points to be outliers, and remove the outliers.

In addition, since a facility, such as a sign, has high reflectivity, points corresponding to the facility appears to have relatively high intensity. Accordingly, the facility updating part 315 may filter noise points based on the intensity of the point clouds included in the bounding box. That is, the facility updating part 315 may classify points with an intensity lower than a preset value among the point clouds included in the bounding box, as noise points and filter them.

Meanwhile, when performing clustering, the facility updating part 315 may generate at least one first cluster instance by applying a Euclidean clustering algorithm to the collected point cloud. That is, the facility updating part 315 may perform clustering based on the Euclidean distance according to the equation below.

$$d ( x , y ) = \sqrt{{( {x}_{1} - {y}_{1} )}^{2} + … + {( \text{?} - \text{?} )}^{2}} \qquad [ Equation ]$$

$$\text{?} \text{indicates text missing or illegible when filed}$$

(Here, x and y include any two points included within the bounding box.)

At this time, the facility updating part 315 may identify at least one generated first cluster instance as an object.

The facility updating part 315 may generate at least one second cluster instance based on the class name of the points included in the at least one generated first cluster instance and identify the generated second cluster instance as an object. That is, the facility updating part 315 may calculate a score value of at least one first cluster instance for each class name, and if the calculated score value is greater than or equal to a preset value, it may be regarded as at least one second cluster instance, but the present disclosure is not limited thereto. For example, the facility updating part 315 may calculate a score value for each class name, and if the ratio of the score values is 0.1 or more, it may be regarded as a second cluster instance.

In addition, the facility updating part 315 may generate at least one third cluster instance by applying the Euclidean clustering algorithm to each of the at least one second cluster instance.

In addition, the facility updating part 315 may identify at least one generated third cluster instance as an object. That is, the facility updating part 315 may set a representative point representing each of at least one third cluster instance, extract coordinates corresponding to the representative point, and identify the coordinates of the object. For example, the facility updating part 315 may set a point having the highest intensity among the plurality of points corresponding to each of the at least one third cluster instance, as the representative point.

In this manner, the facility updating part 315 may more clearly distinguish adjacent facilities from each other through step-by-step clustering of the collected point clouds and may intuitively confirm the process for identifying the facility.

The facility updating part 315 may update object information on the reference map by mapping the identified object with the object on the reference map and may give a status value according to new, deletion, movement, and change to the updated object on the reference map. In other words, the facility updating part 315 may support to facilitate facility management by updating the facility status on the reference map and also storing status values, such as whether the facility is new or deleted.

As a next component, the facility management part 320 may detect a facility through an image captured by the camera mounted on the vehicle traveling on the road, determine whether the detected facility is damaged to manage the same.

To this end, the facility management part 320 may identify an object corresponding to a preset facility in the image captured by the camera.

Here, the facility may be a median strip installed on the road.

The median strip may include vertical bars spaced apart at regular intervals along the center line and horizontal bars connecting a pair of adjacent vertical bars. Meanwhile, in the following description, a pair of vertical bars and at least one horizontal bar connecting the pair of vertical bars are described as one central separator.

Meanwhile, it is stipulated that median strips should be installed on roads with four or more lanes. Accordingly, the facility management part 320 may identify a road in the image and identify an object when the number of lanes on the identified road is equal to or greater than a preset number. Through this, the facility management part 320 may shorten the time required to identify an object by selectively extracting only images in which a median strip is expected to exist.

Specifically, the facility management part 320 may set a region of interest (ROI) within the image. At this time, the facility management part 320 may set a rectangle having a preset size including a specific point located at a left lower end of the image as a left lower end vertex as the ROI. In other words, the camera acquires an image of the front of the vehicle driving on the road. Accordingly, due to the characteristics of domestic roads, the median strip is located at the left lower end of the image. Accordingly, the facility management part 320 may designate the left lower end of the image as the ROI, thereby reducing the amount of calculation required for specifying the bounding box because the entire image is not considered. Meanwhile, the facility management part 320 may set the ROI to the lower right end when operating overseas where the road direction is opposite to that in Korea.

Thereafter, the facility management part 320 may perform segmentation within the set ROI and designate at least one bounding box corresponding to the object. That is, the facility management part 320 may set a bounding box for the region corresponding to the object in the received image based on artificial intelligence (AI) that has been machine-trained in advance based on the pre-stored object model.

Here, the bounding box is a region for specifying an object corresponding to a facility among the objects included in the image. That is, the bounding box may specify each median strip including a pair of vertical bars and a horizontal bar connecting the vertical bars. As such, the bounding box may have a rectangle or polygon shape, but is not limited thereto.

Meanwhile, the median strip located at the left lowermost end on the left in the ROI is not fully captured in a camera angle, and thus, the median strip is captured in the image in a truncated form.

Accordingly, when a plurality of bounding boxes are designated within the ROI, the facility management part 320 may detect a bounding box that is closest in distance to a specific point and exclude the detected bounding box. Here, the specific point may be a left lowermost end portion of the ROI as described above.

Meanwhile, even if the median strip is located at the left lowermost end the ROI, the entire median strip imaged at the end of the median strip may be captured in the camera angle. Accordingly, the facility management part 320 may exclude the detected bounding box but exclude the detected bounding box when the bounding box is continuously detected a preset number of times at the position of the bounding box first detected in the image continuously received by the camera. In other words, if the median strip is not detected at the corresponding location after the median strip is first detected at the left lower end in the image sorted by time, it may be determined as a point at which the median strip is over, and when the median strip is continuously detected at the corresponding location, it is determined that the median strip is not fully captured in the camera angle, and the median strip may be excluded.

However, the present disclosure is not limited thereto, and when a plurality of bounding boxes are designated within the ROI, the facility management part 320 may detect a bounding box located within a rectangle having a preset size that includes a specific point as the left lower end vertex, and may exclude the detected bounding box. That is, the facility management part 320 may determine that the median strip existing in a specific region within the ROI as a median strip that is entirely captured in the camera angle, and may exclude all of them.

Next, the facility management part 320 may process the image to accurately determine whether the identified object is damaged.

Specifically, the facility management part 320 may replace the values of all pixels within the bounding box with a local minimum in order to approach the image from a morphological perspective. That is, the facility management part 320 may replace neighboring pixels with the minimum pixel value by using structural elements. Through this, the facility management part 320 may reduce a bright region in the image and increase the dark region, and the dark region increases according to the size or number of repetitions of a kernel, causing speckles to disappear, and noise may be removed by making internal holes of the object corresponding to the median strip larger.

Meanwhile, in the image, pixels in the (x, y) coordinate space appear in the form of a curve in a (r, θ) parameter space. In addition, pixels that exist on the same straight line in the (x, y) coordinate space have an intersection point in a (r, θ) parameter space.

Accordingly, the facility management part may map the pixels existing in the bounding box from the (x, y) coordinate space to the (r, θ) parameter space, derive an intersection point, and extract an edge corresponding to a straight line component based on the pixel corresponding to the derived intersection point. That is, the facility management part 320 may detect at least one horizontal bar from the median strip existing within the bounding box.

In addition, the facility management part 320 may determine whether the object corresponding to the processed image is damaged.

Specifically, the facility management part 320 may generate a plurality of straight lines parallel to each other formed in a height direction of the bounding box at preset intervals within the bounding box and determine whether the object is damaged based on the number of contact points between the extracted edges and the plurality of generated straight lines. That is, the facility management part 320 may generate a plurality of virtual lines parallel to the y-axis of the image and spaced apart from each other at a certain distance and determine whether each horizontal bar is damaged based on the number of contact points with each virtual line for each horizontal bar.

For example, in a normal horizontal bar, two contact points are detected per virtual line. Meanwhile, a broken horizontal bar may have no contact points.

Accordingly, the facility management part 320 may identify the number of at least one horizontal bar included in the median strip based on the number of contact points between the extracted edge and the plurality of generated straight lines, and if the number of horizontal bars is less than the preset value, the median strip may be determined to be damaged.

In addition, if it is determined that the median strip is damaged, the facility management part 320 may change the pixel corresponding to the damaged object on the pre-stored map to a preset color. For example, if the pre-stored map is a map including point cloud data acquired by the LiDAR, the facility management part 320 may display the point cloud corresponding to the damaged object in red to support a manager to intuitively detect the damage to the facility.

In addition, the facility management part 320 may detect a facility in the image captured by the camera mounted on the vehicle traveling on the road and recognize text written on the detected facility to identify the type of facility.

To this end, the facility management part 320 may identify an object corresponding to a preset facility on the image captured by the camera.

Specifically, the facility management part 320 may perform segmentation on the image and designate at least one bounding box corresponding to the object. That is, the facility management part 320 may designate at least one bounding box corresponding to an object in the image based on artificial intelligence (AI), which is machine-trained in advance based on the facility image.

Next, the facility management part 320 may recognize text included in the identified object. For example, the facility management part 320 may recognize text through optical character recognition (OCR).

Meanwhile, when encoding is performed in the process of recognizing Hangul, even if it is the same word, there is a format in which a consonant and a vowel of the Hangul string are displayed together and a format in which a consonant and a vowel are separated.

For example, when encoding two identical sentences, ‘Slow down,’ as shown in the code below, the length of the strings may be different.

str1=‘Slow down’

str2=‘Slow down’

>>>print(temp_str1.encode(‘utf-8’))

>>>print(temp_str2.encode(‘utf-8’))

b′ [symbol] xec [symbol] xa0 [symbol] x84 [symbol] xea [symbol] xb5 [symbol] xad [symbol] xeb [symbol] xb3 [symbol] xb4 [symbol] xed [symbol] x96 [symbol] x89 [symbol] xec [symbol] x9e [symbol] x90

[symbol]

xec [symbol] xa0 [symbol] x84 [symbol] xec [symbol] x9a [symbol] xa9 [symbol] xeb [symbol] x8f [symbol] x84 [symbol] xeb [symbol] xa1 [symbol] x9c [symbol] xed [symbol] x91 [symbol] x9c [symbol] xec [symbol] xa4 [symbol] x80 [symbol] xeb [symbol] x

8d [symbol] xb0 [symbol] xec [symbol] x9d [symbol] xb4 [symbol] xed [symbol] x84 [symbol] xb0′

b′ [symbol] xe1 [symbol] x84 [symbol] x8c [symbol] xe1 [symbol] x85 [symbol] xa5 [symbol] xe1 [symbol] x86 [symbol] xab [symbol] xe1 [symbol] x84x [symbol] 80 [symbol] xe1 [symbol] x85 [symbol] xae

[symbol]

xe1 [symbol] x86 [symbol] xa8 [symbol] xe1 [symbol] x84 [symbol] x87 [symbol] xe1 [symbol] x85 [symbol] xa9 [symbol] xe1 [symbol] x84 [symbol] x92 [symbol] xe1 [symbol] x85 [symbol] xa2 [symbol] xe1 [symbol] x86 [symbol] xbc [symbol] xe1 [symbol] x

84 [symbol] x8c [symbol] xe1 [symbol] x85 [symbol] xa1 [symbol] xe1 [symbol] x84 [symbol] x8c [symbol] xe1 [symbol] x85 [symbol] xa5 [symbol] xe1 [symbol] x86 [symbol] xab [symbol] xe1′

Accordingly, the facility management part 320 may normalize the Unicode corresponding to the recognized text using an NFC method in order to solve the phenomenon that the consonants and vowels of the Korean character string are separated and cannot be compared. In addition, text may be recognized by comparing the normalized Unicode with the pre-stored Unicode normalized using the NFC method.

Meanwhile, in a general optical character recognition model, a problem in which precision decreases depending on the state of the text included in the actual image. Accordingly, the facility management part 320 may determine the similarity with the pre-stored correct answer string based on a character error rate (CER), which represents a character error rate between a string identified through optical character recognition and the correct answer string. Here, the facility management part 320 may calculate a character error rate based on the minimum number of insertions, deletions, and changes required for the character string recognized through optical character recognition to be the same as the pre-stored correct answer character string.

For example, the facility management part 320 may calculate the character error rate using the following equation.

$$CER = \frac{S + D + I}{N} \qquad [ Equation ]$$

(Here, S denotes a substitution error, the number of misspelled uniliterals/words, D denotes a deletion error, the number of missing uniliterals/words, and I denotes an insertion error, the number of times incorrect uniliterals/words are included.)

The facility management part 320 may recognize text based on a string with the minimum character error rate among the pre-stored correct answer strings.

In addition, the facility management part 320 may identify the type of facility corresponding to the identified object based on the recognized text. That is, the facility management part 320 may identify the type of facility by comparing the recognized text with a pre-stored facility list.

Meanwhile, the facility management part 320 may record and manage the identified type of facility on a pre-stored map. In addition, if the identified facility does not exist in the existing map but is an added facility, the facility management part 320 may update the existing map based on the captured image.

At this time, the facility management part 320 may replace an image model corresponding to the identified type of facility with the identified object. That is, in order to update the facility more clearly on the existing map, the facility management part 320 may delete an image region corresponding to the identified object and insert a facility model corresponding to the facility into the deleted region as a replacement.

At this time, the facility management part 320 may replace the image model with the object identified in the image, estimate an angle of the identified object based on a shape of the identified object, and apply the estimated angle to the image model to identify the object. Here, the facility management part 320 may extract the edge of the identified object based on the RGB value within the bounding box corresponding to the identified object, and estimate the shape of the object through the extracted edge.

As a next component, the noise removal part 325 may remove noise due to a dynamic object in the process of acquiring data to generate a map.

To this end, the noise removal part 325 may receive point cloud data acquired from the LiDAR and an image captured by the camera. At this time, the noise removal part 325 may compress the received image to reduce the capacity of the segmentation result for identifying the object. That is, the noise removal part 325 may determine whether the data of the image previously existed through a dictionary-type compression algorithm to indicate whether it is repetitive, encode the image, and compress the image by assigning different prefix codes according to the frequency of appearance of characters included in the image. Through this, the noise removal part 325 may not only reduce the size of the image at a fast processing rate, but also maintain the quality.

Next, the noise removal part 325 may identify a preset object from the image.

Specifically, the noise removal part 325 may identify a preset object in the image through segmentation based on artificial intelligence (AI) that has been previously machine-trained.

For example, the noise removal part 325 may designate a bounding box in a region corresponding to the preset object in the image. Here, the bounding box is a region for specifying an object corresponding to noise among objects included in the image. As such, the bounding box may have a rectangle or polygon shape, but is not limited thereto.

However, without being limited thereto, the noise removal part 325 may identify the object by performing semantic segmentation on the image based on artificial intelligence that has been machine-trained in advance based on data corresponding to the object.

In addition, the noise removal part 325 may record time stamps for images continuously received by the camera, sorts the continuously received images based on the recorded time stamps, and identify the object based on a similarity between neighboring images among the sorted images.

That is, the purpose of the noise removal part 325 is to recognize a dynamic object as noise in the image and delete the same. Accordingly, the noise removal part 325 may identify an object whose similarity between consecutive images is higher than a preset value as a dynamic object. At this time, the noise removal part 325 may identify an object moving within the image based on the amount of change in RGB (red, green, and blue) between neighboring images.

Next, the noise removal part 325 may delete a point cloud corresponding to the object identified from the image from the point cloud data.

Specifically, the noise removal part 325 may perform calibration on the image and point cloud data, and delete the point cloud at the same coordinates as the object identified on the image.

At this time, the noise removal part 325 may group point clouds included in the object identified on the image into a plurality of unit point clouds based on distance values from the LiDAR, identify a unit point cloud in which the distance value from the LiDAR among the plurality of unit point clouds is the shortest, as a point cloud corresponding to the object, and delete the same. That is, since point cloud data is acquired by the LiDAR mounted on a vehicle, the noise removal part 325 may identify and delete a point cloud with a relatively short distance value from the LiDAR as a vehicle, which is one of the dynamic objects.

In addition, the noise removal part 325 may identify an outlier among point clouds included in the object identified on the image based on the density and delete point clouds excluding the identified outlier. That is, the point clouds included in the object identified on the image may have a possibility of including point clouds of other objects other than the dynamic object corresponding to noise. Accordingly, the noise removal part 325 may identify a point cloud included in an object other than the object identified based on the density as an outlier and delete the point cloud excluding the identified object.

In addition, the noise removal part 325 may identify at least one object based on the density within the point cloud data acquired from the LiDAR, and among the identified at least one object, the noise removal part 325 may additionally delete a point cloud included in the object in which an amount of change in distance exceeds a preset value.

Meanwhile, in the above description, the noise removal part 325 generates a map based on point cloud data from which a point cloud corresponding to an object identified from the image was deleted. However, the present disclosure is not limited thereto, and the noise removal part 325 may delete a point cloud corresponding to the identified object on the map pre-generated based on the point cloud data acquired from the LiDAR and the image captured by the camera. That is, the noise removal part 325 may delete the object identified on the previously stored map.

As a next component, the model lightweight unit 330 may lighten the AI model to increase an inference speed, while maintaining the accuracy of the AI model for detecting an object in the image captured by the camera as much as possible. Here, the AI model may be an AI model for detecting an object on the image captured by the camera.

To this end, the model lightweight unit 330 may perform pruning on the AI model machine-trained using a first data set.

Specifically, when a weight value of each layer included in the AI model is less than or equal to a preset value, the model lightweight unit 330 may convert the corresponding weight to ‘0’. In other words, the model lightweighting part 330 may reduce a parameter of the AI model by removing a connection of a low-importance weight among the weights of the AI model.

At this time, the model lightweight unit 330 may analyze sensitivity of the AI model. Here, the sensitivity parameter may be a parameter that determines which weight or layer is most affected when pruning. In order to calculate the sensitivity parameter of the AI model, the model lightweighting part 330 may derive the sensitivity parameter by performing iterative pruning by applying a preset threshold for the weight to the AI model.

The model lightweight unit 330 may determine a threshold for the weight value by multiplying the sensitivity parameter according to the analyzed sensitivity by a standard deviation for the weight value distribution of the AI model.

For example, the threshold for the weight value may be set as in the following equation.

$$thresh ( {w}_{i} ) = \{ \begin{matrix}{w}_{i} : if \vert {w}_{i} \vert > λ \\ 0 : if \vert {w}_{i} \vert \leq λ\end{matrix} \} \qquad [ Equation ]$$

(Here, λ may be s*σₗ, σₗ may be the standard of layer l measured in a denso model, and s may be a sensitivity parameter.)

In other words, the model lightweight unit 330 may utilize the fact that a weight distribution of the convolution layer and fully connected layer of the AI model has a Gaussian distribution.

Thereafter, the model lightweight unit 330 may quantize the pruned AI model.

Specifically, the model lightweight unit 330 may convert an AI model including a “floating point 32-bit type” into a “signed 8-bit integer type.” However, without being limited thereto, and the model lightweight unit 330 may convert the weight of the AI model and an input between each layer into binary values according to the sign.

That is, the model lightweight unit 330 may calculate the minimum and maximum values among float values (floating point 32-bit) of each layer. In addition, the model lightweight unit 330 may map the corresponding float values to the linearly closest integer value (signed 8-bit integer). For example, if a float value range of the existing layer is −3.0 to 6.0, the model lightweight unit 330 may map −3.0 to −127 and 6.0 to +127.

At this time, the model lightweight unit 330 may quantize a plurality of weights of the AI model, and may quantize activation at the time of inference.

In another embodiment, the model lightweight unit 330 may quantize a plurality of weights of the AI model and pre-quantize the plurality of weights and activations at an inference time.

In another embodiment, the model lightweight unit 330 may determine a plurality of weights and perform quantization at the same time by simulating in advance impact of applying quantization during inference at the time of training the AI model.

In addition, the model lightweight unit 330 may train the AI model by imitating another AI model pre-trained with a second data set including a larger amount of data than the first data set.

Specifically, the model lightweighting part 330 may calculate a loss by comparing outputs of the AI model and other AI models and train the AI model so that the calculated loss is minimized.

That is, the model lightweight unit 330 may learn by imitating other AI models based on a loss function according to the equation below.

$$Total Loss = ( 1 - α ) {L}_{CE} ( σ ( \text{?} ) , \hat{y} ) + 2 α \text{?} {L}_{CE} ( σ ( \frac{\text{?}}{T} ) , σ ( \frac{\text{?}}{T} ) ) \qquad [ Equation ]$$

$$\text{?} \text{indicates text missing or illegible when filed}$$

(Here, L_{CE} is cross entropy loss, σ is softmax, Zₛ is output logits of the AI model, Zₜ is the output logits of the other AI model, ŷ is ground truth (one-hot), α is balancing parameter, and T is temperature hyperparameter.)

In other words, the model lightweighting part 330 may calculate a difference between the output logits of the ground truth and the AI model as cross entropy loss as a loss in the classification performance of the AI.

In addition, the model lightweight unit 330 may include the difference in classification results between the other AI model and AI models in the loss. In addition, the model lightweighting part 330 may calculate the difference between the output logits of other AI model and the AI model converted into softmax as cross entropy loss. At this time, the model lightweight unit 330 may take a small value when the classification results of the other AI model and the AI model are the same.

Meanwhile, α may be a parameter for the weights for the left and right terms. T may be a parameter that alleviates the qualities of the softmax function of making a large input value very large and a small input value very small.

In other words, the model lightweighting part 330 may train by imitating the AI model as a lightweight target which is a relatively small model, through the output of the other AI model which is trained in advance, thereby improving the performance of the model even if it has relatively few parameters.

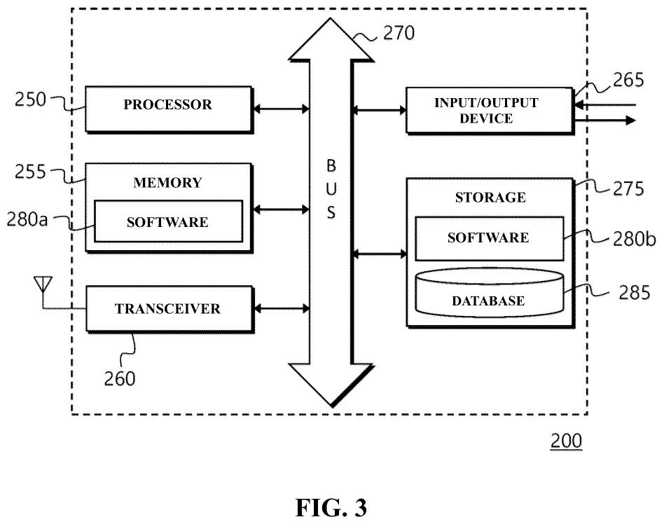

FIG. 3 is a hardware configuration diagram of a data processing device according to an embodiment of the present disclosure.

Referring to FIG. 3, the data processing device 300 may include a processor 350, a memory 355, a transceiver 360, an input/output device 365, a data bus 370, and a storage 375.

The processor 350 may implement the operation and function of the data processing device 300 based on instructions according to a software 380a loaded in the memory 355. The software 380a implementing the method according to the present disclosure may be loaded in the memory 355. The transceiver 360 may transmit and receive data to and from the data collecting device 100 and the data generating device 200.

The input/output device 365 may receive data required for the operation of the data processing device 300 and output the generated result value. The data bus 370 may be connected to the processor 350, the memory 355, the transceiver 360, the input/output device 365, and the storage 375 and serve as a movement passage for transferring data between each component.

The storage 375 may store an application programming interface (API), a library file, a resource file, etc. required for the execution of the software 380a in which another method according to the present disclosure is implemented. The storage 375 may store a software 380b in which the method according to the present disclosure is implemented. In addition, the storage 375 may store information necessary for performing the method. In particular, the storage 375 may include a database 385 that stores a program for performing the method.

According to an embodiment of the present disclosure, the software 380a or 380b loaded in the memory 355 or stored in the storage 375 may be a computer program recorded on a recording medium to execute an operation of receiving, by the processor 350, point cloud data from the LiDAR installed in the vehicle traveling on the path on the pre-stored reference map and a captured image from a camera, an operation of identifying, by the processor 350, an object based on the received point cloud data and the image, and an operation of updating, by the processor, facility information on the reference map by matching an object identified by the processor 350 to a reference map.

According to another embodiment of the present disclosure, the software 380a, 380b loaded in the memory 355 or stored in the storage 375 may be a computer program recorded on a recording medium to execute an operation of receiving, by the processor 350, point cloud data acquired from the LiDAR and an image captured by a camera, an operation of identifying, by the processor 350, a preset object from an image; and an operation of deleting, by the processor 350, a point cloud corresponding to the object identified from the image, and an operation of executing, by the processor 350, a map based on the point cloud data from which the point cloud corresponding to the object is deleted.

According to another embodiment of the present disclosure, the software 380a or 380b loaded in the memory 355 or stored in the storage 375 may be a computer program recorded on a recording medium to execute an operation of identifying, by the processor 350, an object corresponding to a preset facility on an image captured by a camera, an operation of processing, by the processor 350, an image on the identified object, an operation of determining, by the processor 350, whether the object corresponding to the processed image is damaged.

According to another embodiment of the present disclosure, the software 380a or 380b loaded in the memory 355 or stored in the storage 375 may be a computer program recorded on a recording medium to execute an operation of performing pruning, by the processor 350, on an AI model machine-trained by a first data set, an operation of quantizing, by the processor 350, the pruned AI model, and an operation of training, by the processor 350, the AI model by imitating another AI model pre-trained with a second data set including a data amount greater than the first data set.

According to another embodiment of the present disclosure, the software 380a or 380b loaded in the memory 355 or stored in the storage 375 may be a computer program recorded on a recording medium to execute an operation, by the processor 350, an object corresponding to a pre-set facility on an image captured by a camera, an operation of recognizing, by the processor 350, text included in the identified object, and an operation of identifying, by the processor 350, a type of facility corresponding to the identified object based on the recognized text.

More specifically, the processor 350 may include an application-specific integrated circuit (ASIC), another chipset, a logic circuit, and/or a data processing device. The memory 355 may include read-only memory (ROM), random access memory (RAM), flash memory, a memory card, a storage medium, and/or other storage devices. The transceiver 360 may include a baseband circuit for processing wired and wireless signals. The input/output device 365 may include input devices, such as a keyboard, a mouse, and/or a joystick, image output devices, such as a liquid crystal display (LCD), an organic light emitting diode (OLED), and/or, an active matrix OLED (AMOLED), and printing devices, such as a printer, a plotter, etc.

When the embodiments included in this specification are implemented as software, the aforementioned method may be implemented as a module (process, function, etc.) that performs the aforementioned function. The module may reside in the memory 355 and may be executed by the processor 350. The memory 355 may be internal or external to the processor 350 and may be coupled to the processor 350 by a variety of well-known units.

Each component shown in FIG. 3 may be implemented by various units, for example, hardware, firmware, software, or a combination thereof. In the case of implementation by hardware, an embodiment of the present disclosure may be implemented by one or more of application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc.

In addition, in case of implementation by firmware or software, an embodiment of the present disclosure is implemented in the form of a module, procedure, function, etc. that performs the functions or operations described above and may be recorded in a readable recording medium through various computer units. Here, the recording medium may include program instructions, data files, data structures, or the like, alone or in combination. The program instructions recorded in the recording medium may be specially designed and configured for the present disclosure or may be known and available to those skilled in computer software. For example, the recording medium includes magnetic mediums such as hard disks, floppy disks, and magnetic tapes, optical mediums such as compact disk read only memory (CD-ROM) or digital video disk (DVD), magneto-optical mediums such as floptical disks, and a hardware device specially configured to store and execute program instructions such as ROM, RAM, flash memory, and the like. Examples of the program instructions include machine codes made by, for example, a compiler, as well as high-level language codes executable by a computer, using an interpreter. The above exemplary hardware device may be configured to operate as at least one software module in order to perform the embodiments of the present disclosure, and vice versa.

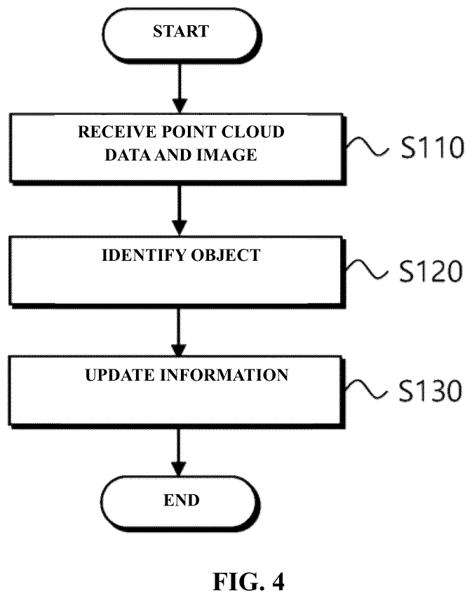

FIG. 4 is a flowchart illustrating a facility updating method according to an embodiment of the present disclosure.

Referring to FIG. 4, first, in operation S110, the data processing device may receive point cloud data acquired from a LiDAR installed on a vehicle traveling on a route of a pre-stored reference map and an image captured through a camera.

Next, in operation S120, the data processing device may identify an object corresponding to a facility based on the received point cloud data and image.

Specifically, the data processing device may set a bounding box for a region corresponding to an object within the received image. At this time, the data processing device may set a bounding box for the region corresponding to the object in the received image based on an AI, which has been machine-trained in advance based on a pre-stored object model.

In addition, the data processing device may collect a point cloud included in the bounding box by projecting the point cloud data onto the image. That is, the data processing device may collect points included in the bounding box by projecting the point cloud data acquired from the LiDAR through calibration of the camera and LiDAR onto the image. At this time, the data processing device may accumulate and store the points included in the bounding box for a plurality of images that are continuously received.

In addition, the data processing device may classify the collected point cloud and perform clustering in units of objects. That is, the data processing device may cluster the collected point cloud in units of objects based on point attributes including one of GPS coordinates, density, and a class name.

Meanwhile, when performing clustering, the data processing device may generate at least one first cluster instance by applying a Euclidean clustering algorithm to the collected point cloud. That is, the data processing device may perform clustering based on the Euclidean distance according to the equation below.

$$d ( x , y ) = \sqrt{{( {x}_{1} - {y}_{1} )}^{2} + … + {( \text{?} - \text{?} )}^{2}} \qquad [ Equation ]$$

$$\text{?} \text{indicates text missing or illegible when filed}$$

(Here, x and y include any two points included within the bounding box.)

At this time, the data processing device may identify at least one generated first cluster instance as an object.

The data processing device may generate at least one second cluster instance based on the class name of the points included in the at least one generated first cluster instance and identify the generated second cluster instance as an object. That is, the data processing device may calculate a score value of at least one first cluster instance for each class name, and if the calculated score value is greater than or equal to a preset value, it may be regarded as at least one second cluster instance, but the present disclosure is not limited thereto.

The data processing device may generate at least one third cluster instance by applying the Euclidean clustering algorithm to each of the at least one second cluster instance.

In addition, the data processing device may identify at least one generated third cluster instance as an object. That is, the data processing device may set a representative point representing each of at least one third cluster instance, extract coordinates corresponding to the representative point, and identify the coordinates of the object.

Also, in operation S130, the data processing device may update the object information on the reference map by matching the identified object with the reference map.

Specifically, the data processing device may update object information on the reference map by mapping the identified object with the object on the reference map and may give a status value according to new, deletion, movement, and change to the updated object on the reference map.

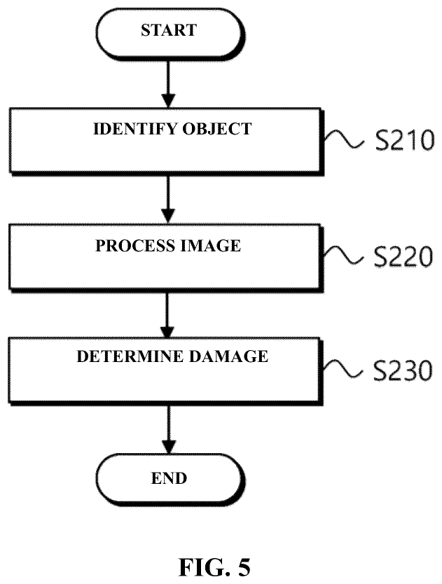

FIG. 5 is a flowchart illustrating a facility management method according to an embodiment of the present disclosure.

Referring to FIG. 5, first, in operation S210, the data processing device may identify an object corresponding to a preset facility on an image captured by the camera.

Here, the facility may be a median strip installed on the road. The median strip may include vertical bars spaced apart at regular intervals along the center line and horizontal bars connecting a pair of adjacent vertical bars.

Specifically, the data processing device may set a region of interest (ROI) within the image. At this time, the data processing device may set a rectangle having a preset size including a specific point located at a left lower end of the image as a left lower end vertex as the ROI. In other words, the camera acquires an image of the front of the vehicle driving on the road. Accordingly, due to the characteristics of domestic roads, the median strip is located at the left lower end of the image. Accordingly, the data processing device may designate the left lower end of the image as the ROI, thereby reducing the amount of calculation required for specifying the bounding box because the entire image is not considered.

Thereafter, the data processing device may perform segmentation within the set ROI and designate at least one bounding box corresponding to the object. That is, the data processing device may set a bounding box for the region corresponding to the object in the received image based on artificial intelligence (AI) that has been machine-trained in advance based on the pre-stored object model.

At this time, when a plurality of bounding boxes are designated within the ROI, the data processing device may detect a bounding box that is closest in distance to a specific point and exclude the detected bounding box. Here, the specific point may be a left lowermost end portion of the ROI as described above.

Meanwhile, even if the median strip is located at the left lowermost end the ROI, the entire median strip imaged at the end of the median strip may be captured in the camera angle. Accordingly, the data processing device may exclude the detected bounding box but exclude the detected bounding box when the bounding box is continuously detected a preset number of times at the position of the bounding box first detected in the image continuously received by the camera. In other words, if the median strip is not detected at the corresponding location after the median strip is first detected at the left lower end in the image sorted by time, it may be determined as a point at which the median strip is over, and when the median strip is continuously detected at the corresponding location, it is determined that the median strip is not fully captured in the camera angle, and the median strip may be excluded.

However, the present disclosure is not limited thereto, and when a plurality of bounding boxes are designated within the ROI, the data processing device may detect a bounding box located within a rectangle having a preset size that includes a specific point as the left lower end vertex, and may exclude the detected bounding box. That is, the data processing device may determine that the median strip existing in a specific region within the ROI as a median strip that is entirely captured in the camera angle, and may exclude all of them.

Next, in operation S220, the data processing device may process the image to accurately determine whether the identified object is damaged.

Specifically, the data processing device may replace the values of all pixels within the bounding box with a local minimum in order to approach the image from a morphological perspective. That is, data processing device may replace neighboring pixels with the minimum pixel value by using structural elements. Through this, the data processing device may reduce a bright region in the image and increase the dark region, and the dark region increases according to the size or number of repetitions of a kernel, causing speckles to disappear, and noise may be removed by making internal holes of the object corresponding to the median strip larger.

Meanwhile, in the image, pixels in the (x, y) coordinate space appear in the form of a curve in a (r, θ) parameter space. In addition, pixels that exist on the same straight line in the (x, y) coordinate space have an intersection point in a (r, θ) parameter space.

Accordingly, the data processing device may map the pixels existing in the bounding box from the (x, y) coordinate space to the (r, θ) parameter space, derive an intersection point, and extract an edge corresponding to a straight line component based on the pixel corresponding to the derived intersection point. That is, the data processing device may detect at least one horizontal bar from the median strip existing within the bounding box.

Also, in operation S230, the data processing device may determine whether the object corresponding to the processed image is damaged.

Specifically, the data processing device may generate a plurality of straight lines parallel to each other formed in a height direction of the bounding box at preset intervals within the bounding box and determine whether the object is damaged based on the number of contact points between the extracted edges and the plurality of generated straight lines. That is, the data processing device may generate a plurality of virtual lines parallel to the y-axis of the image and spaced apart from each other at a certain distance and determine whether each horizontal bar is damaged based on the number of contact points with each virtual line for each horizontal bar.

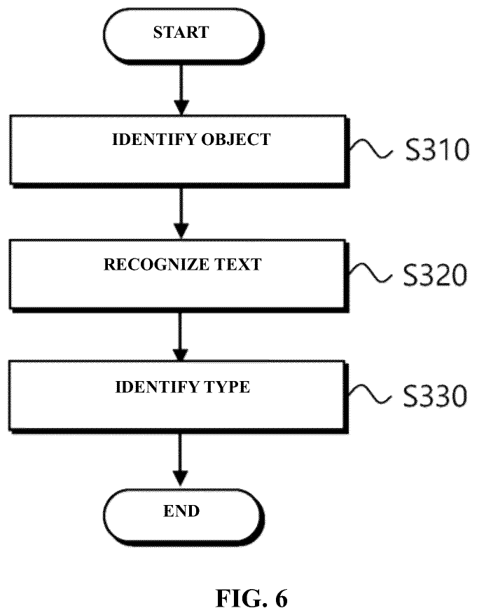

FIG. 6 is a flowchart illustrating a facility management method according to another embodiment of the present disclosure.

Referring to FIG. 6, first, in operation S310, the data processing device may identify an object corresponding to a preset facility on the image captured by the camera.

Specifically, the data processing device may perform segmentation on the image and designate at least one bounding box corresponding to the object. That is, the data processing device may designate at least one bounding box corresponding to an object in the image based on artificial intelligence (AI), which is machine-trained in advance based on the facility image.

Next, in operation S320, the data processing device may recognize text included in the identified object.

At this time, the data processing device may normalize the Unicode corresponding to the recognized text using an NFC method in order to solve the phenomenon that the consonants and vowels of the Korean character string are separated and cannot be compared. In addition, text may be recognized by comparing the normalized Unicode with the pre-stored Unicode normalized using the NFC method.

In addition, the data processing device may determine the similarity with the pre-stored correct answer string based on a character error rate (CER), which represents a character error rate between a string identified through optical character recognition and the correct answer string. Here, the data processing device may calculate a character error rate based on the minimum number of insertions, deletions, and changes required for the character string recognized through optical character recognition to be the same as the pre-stored correct answer character string.

The data processing device may calculate the text error rate using the following equation.

$$CER = \frac{S + D + I}{N} \qquad [ Equation ]$$

(Here, S denotes a substitution error, the number of misspelled uniliterals/words, D denotes a deletion error, the number of missing uniliterals/words, and I denotes an insertion error, the number of times incorrect uniliterals/words are included.)

The data processing device may recognize text based on a string with the minimum character error rate among the pre-stored correct answer strings.

Also, in operation S330, the data processing device may identify the type of facility corresponding to the identified object based on the recognized text. That is, the data processing device may identify the type of facility by comparing the recognized text with a pre-stored facility list.

Meanwhile, the data processing device may record and manage the identified type of facility on a pre-stored map. In addition, if the identified facility does not exist in the existing map but is an added facility, the data processing device may update the existing map based on the captured image.

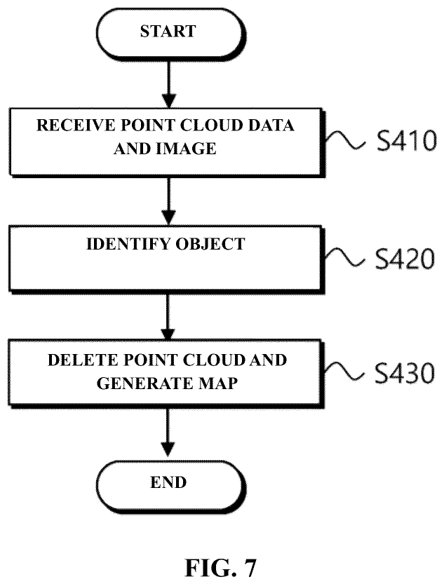

FIG. 7 is a flowchart illustrating a noise removal method according to an embodiment of the present disclosure.

Referring to FIG. 7, in operation S410, the data processing device may receive point cloud data acquired from the LiDAR and an image captured by the camera.

At this time, the data processing device may compress the received image to reduce the capacity of the segmentation result for identifying the object. That is, the data processing device may determine whether the data of the image previously existed through a dictionary-type compression algorithm to indicate whether it is repetitive, encode the image, and compress the image by assigning different prefix codes according to the frequency of appearance of characters included in the image.

Next, in operation $420, the data processing device may identify a preset object from the image.

Specifically, the data processing device may identify a preset object in the image through segmentation based on artificial intelligence (AI) that has been previously machine-trained.

That is, the data processing device may designate a bounding box in a region corresponding to the preset object in the image. However, without being limited thereto, the data processing device may identify the object by performing semantic segmentation on the image based on artificial intelligence that has been machine-trained in advance based on data corresponding to the object.

In addition, the data processing device may record time stamps for images continuously received by the camera, sorts the continuously received images based on the recorded time stamps, and identify the object based on a similarity between neighboring images among the sorted images.

In other words, the purpose of the data processing device is to recognize a dynamic object as noise in the image and delete the same. Accordingly, the data processing device may identify an object whose similarity between consecutive images is higher than a preset value as a dynamic object. At this time, the data processing device may identify an object moving within the image based on the amount of change in RGB (red, green, and blue) between neighboring images.

Also, in operation S430, the data processing device may delete a point cloud corresponding to the object identified from the image from the point cloud data.

Specifically, the data processing device may perform calibration on the image and point cloud data, and delete the point cloud at the same coordinates as the object identified on the image.

At this time, the data processing device may group point clouds included in the object identified on the image into a plurality of unit point clouds based on distance values from the LiDAR, identify a unit point cloud in which the distance value from the LiDAR among the plurality of unit point clouds is the shortest, as a point cloud corresponding to the object, and delete the same. That is, since point cloud data is acquired by the LiDAR mounted on a vehicle, the data processing device may identify and delete a point cloud with a relatively short distance value from the LiDAR as a vehicle, which is one of the dynamic objects.

In addition, the data processing device may identify an outlier among point clouds included in the object identified on the image based on the density and delete point clouds excluding the identified outlier. That is, the point clouds included in the object identified on the image may have a possibility of including point clouds of other objects other than the dynamic object corresponding to noise. Accordingly, the noise data processing device may identify a point cloud included in an object other than the object identified based on the density as an outlier and delete the point cloud excluding the identified object.

In addition, the data processing device may identify at least one object based on the density within the point cloud data acquired from the LiDAR, and among the identified at least one object and may additionally delete a point cloud included in the object in which an amount of change in distance exceeds a preset value.

In addition, the data processing device may generate a map based on point cloud data from which a point cloud corresponding to an object identified from the image was deleted.

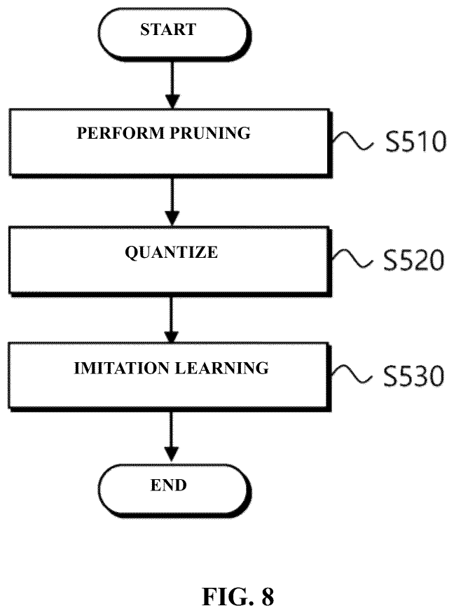

FIG. 8 is a flowchart illustrating an AI model lightweighting method according to an embodiment of the present disclosure.

Referring to FIG. 8, first, in operation S510, the data processing device may perform pruning on the AI model machine-trained using a first data set.

Specifically, when a weight value of each layer included in the AI model is less than or equal to a preset value, the data processing device may convert the corresponding weight to ‘0’. In other words, the data processing device may reduce a parameter of the AI model by removing a connection of a low-importance weight among the weights of the AI model.

At this time, the data processing device may analyze sensitivity of the AI model. Here, the sensitivity parameter may be a parameter that determines which weight or layer is most affected when pruning. In order to calculate the sensitivity parameter of the AI model, the data processing device may derive the sensitivity parameter by performing iterative pruning by applying a preset threshold for the weight to the AI model.

The data processing device may determine a threshold for the weight value by multiplying the sensitivity parameter according to the analyzed sensitivity by a standard deviation for the weight value distribution of the AI model.

For example, the threshold for the weight value may be set as in the following equation.

$$thresh ( {w}_{i} ) = \{ \begin{matrix}{w}_{i} : if \vert {w}_{i} \vert > λ \\ 0 : if \vert {w}_{i} \vert \leq λ\end{matrix} \} \qquad [ Equation ]$$

(Here, λ may be s*σₗ, σₗ may be the standard of layer l measured in a denso model, and s may be a sensitivity parameter.)

In other words, the data processing device may utilize the fact that a weight distribution of the convolution layer and fully connected layer of the AI model has a Gaussian distribution.

Next, the data processing device may quantize the pruned AI model.

Specifically, the data processing device may convert an AI model including a “floating point 32-bit type” into a “signed 8-bit integer type.” However, without being limited thereto, and the data processing device may convert the weight of the AI model and an input between each layer into binary values according to the sign.

That is, the data processing device may calculate the minimum and maximum values among float values (floating point 32-bit) of each layer. In addition, the data processing device may map the corresponding float values to the linearly closest integer value (signed 8-bit integer).

At this time, the data processing device may quantize a plurality of weights of the AI model, and may quantize activation at the time of inference.

In another embodiment, the data processing device may quantize a plurality of weights of the AI model and pre-quantize the plurality of weights and activations at an inference time.

In another embodiment, the data processing device may determine a plurality of weights and perform quantization at the same time by simulating in advance impact of applying quantization during inference at the time of training the AI model.

Also, in operation S530, the data processing device may train the AI model by imitating another AI model pre-trained with a second data set including a larger amount of data than the first data set.

Specifically, the data processing device may calculate a loss by comparing outputs of the AI model and other AI models and train the AI model so that the calculated loss is minimized.

In other words, the data processing device may learn by imitating other AI models based on a loss function according to the equation below.

$$Total Loss = ( 1 - α ) {L}_{CE} ( σ ( \text{?} ) , \hat{y} ) + 2 α \text{?} {L}_{CE} ( σ ( \frac{\text{?}}{T} ) , σ ( \frac{\text{?}}{T} ) ) \qquad [ Equation ]$$

$$\text{?} \text{indicates text missing or illegible when filed}$$

(Here, L_{CE} is cross entropy loss, σ is softmax, Zₛ is output logits of the AI model, Zₜ is the output logits of the other AI model, ŷ is ground truth (one-hot), α is balancing parameter, and T is temperature hyperparameter.)

In other words, the data processing device may calculate a difference between the output logits of the ground truth and the AI model as cross entropy loss as a loss in the classification performance of the AI.

In addition, the data processing device may include may include the difference in classification results between the other AI model and AI models in the loss. In addition, the data processing device may calculate the difference between the output logits of other AI model and the AI model converted into softmax as cross entropy loss. At this time, the data processing device may take a small value when the classification results of the other AI model and the AI model are the same.

Meanwhile, a may be a parameter for the weights for the left and right terms. T may be a parameter that alleviates the qualities of the softmax function of making a large input value very large and a small input value very small.

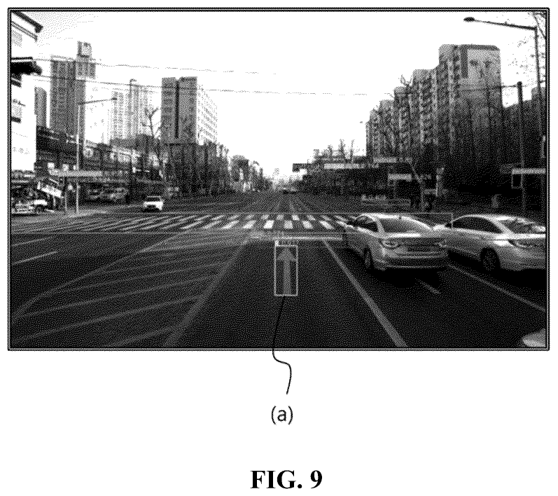

FIGS. 9 to 11 are diagrams illustrating a facility updating method according to an embodiment of the present disclosure.

As shown in FIG. 9, the data processing device may set a bounding box (a) for a region corresponding to a facility, such as a sign, a crosswalk, and a traffic light within the received image.

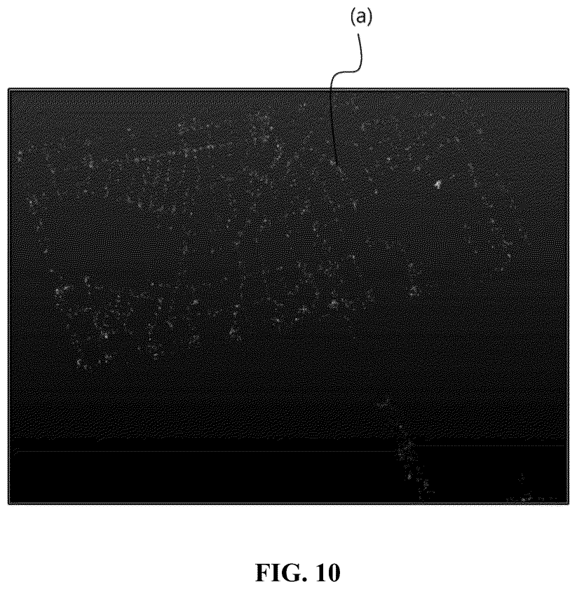

Meanwhile, FIG. 10 is a diagram showing the results of collecting a point cloud included in a bounding box.

As shown in FIG. 10, the data processing device may collect the point clouds included in the bounding box by projecting the point cloud data onto the image.

That is, the data processing device may collect points included in the bounding box by projecting the point cloud data acquired from the LiDAR through calibration of the camera and LiDAR onto the image. At this time, the data processing device may accumulate and store the points included in the bounding box for a plurality of images that are continuously received.

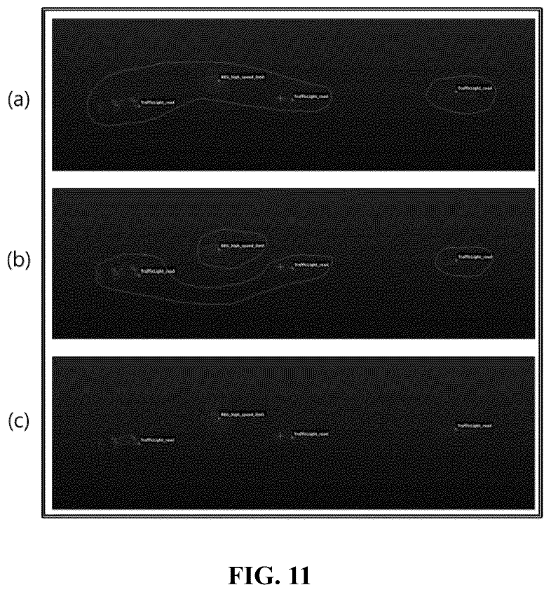

Meanwhile, FIG. 11 is a diagram illustrating the process of classifying the collected point clouds.

As shown in (a) of FIG. 11, the data processing device may generate at least one first cluster instance by applying a Euclidean clustering algorithm to the collected point cloud. That is, the data processing device may perform clustering based on the Euclidean distance according to the equation below.

Thereafter, as shown in (b) of FIG. 11, the data processing device may generate at least one second cluster instance based on the class name of the points included in the at least one generated first cluster instance and identify the generated second cluster instance as an object. That is, the data processing device may calculate a score value of at least one first cluster instance for each class name, and if the calculated score value is greater than or equal to a preset value, it may be regarded as at least one second cluster instance.

And, as shown in (c) of FIG. 11, the data processing device may generate at least one third cluster instance by applying the Euclidean clustering algorithm to each of the at least one second cluster instance.

In addition, the data processing device may identify at least one generated third cluster instance as an object. That is, the data processing device may set a representative point representing each of at least one third cluster instance, extract coordinates corresponding to the representative point, and identify the coordinates of the object.

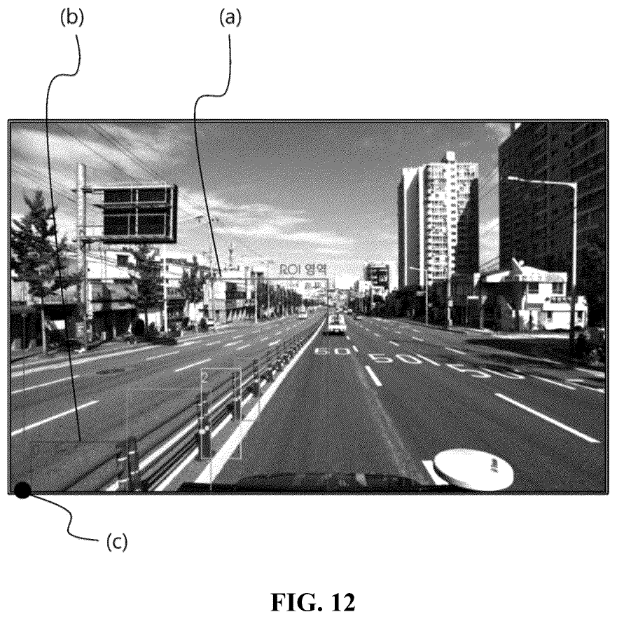

FIGS. 12 to 14 are diagrams illustrating a facility management method according to an embodiment of the present disclosure.

As shown in FIG. 12, the data processing device may set a region of interest (ROI) within the image. At this time, the data processing device may set a rectangle having a preset size including a specific point (c) located at a left lower end of the image as a left lower end vertex as the ROI (a).

At this time, the data processing device may preset the ROI based on the x-axis and y-axis coordinates of the image. For example, the data processing device may set the ROI (a) under the following conditions.

50<x<w/2

0<y<h/2

(Here, w may be a width of the ROI (a), and h may be a height of the ROI (a))

Thereafter, the data processing device may perform segmentation within the set ROI and designate at least one bounding box corresponding to the object.

Meanwhile, the median strip located at the left lowermost end on the left in the ROI is not fully captured in a camera angle, and thus, the median strip is captured in the image in a truncated form.

Accordingly, when a plurality of bounding boxes are designated within the ROI, the data processing device may detect a bounding box (b) that is closest in distance to the specific point (c) and exclude the detected bounding box.

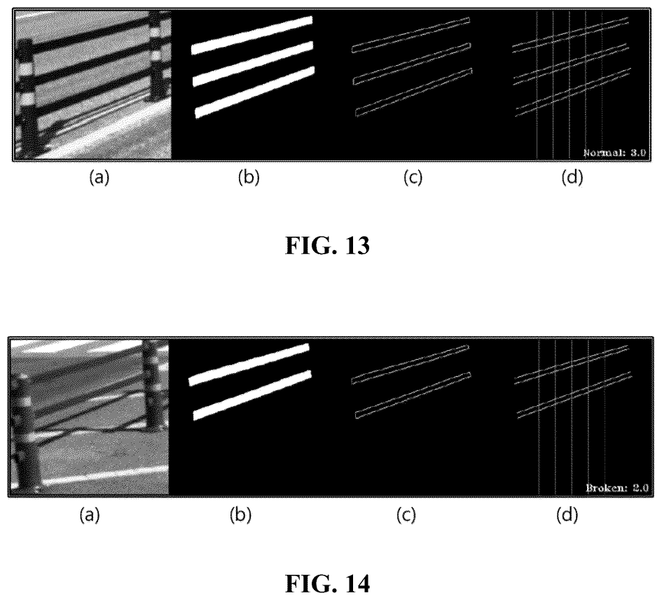

Meanwhile, FIG. 13 is a diagram showing a process of detecting an undamaged median strip, and FIG. 14 is a diagram showing a process of detecting a damaged median strip.

As shown in (a) of FIG. 13, the median strip includes three horizontal bars. The data processing device may detect horizontal bars in the median strip and determine whether they are damaged.

To this end, as shown in (b) of FIG. 13, the data processing device may replace the values of all pixels within the bounding box with a local minimum in order to approach the image from a morphological perspective.

Thereafter, as shown in (c) of FIG. 13, the data processing device may map the pixels existing in the bounding box from the (x, y) coordinate space to the (r, θ) parameter space, derive an intersection point, and extract an edge corresponding to a straight line component based on the pixel corresponding to the derived intersection point. That is, the data processing device may detect at least one horizontal bar from the median strip existing within the bounding box.

In addition, the data processing device may generate a plurality of straight lines parallel to each other formed in a height direction of the bounding box at preset intervals within the bounding box and determine whether the object is damaged based on the number of contact points between the extracted edges and the plurality of generated straight lines. That is, the data processing device may generate a plurality of virtual lines parallel to the y-axis of the image and spaced apart from each other at a certain distance and determine whether each horizontal bar is damaged based on the number of contact points with each virtual line for each horizontal bar.

That is, as shown in (d) of FIG. 13, two contact points are detected per virtual line for each horizontal bar included in the median strip.

Meanwhile, as shown in (d) of FIG. 14, in the case of the median strip in which a horizontal bar located at the lowest end among the three horizontal bars is damaged, there is no contact point with respect to the damaged horizontal bar.

Accordingly, the data processing device may identify the number of at least one horizontal bar included in the median strip based on the number of contact points between the extracted edge and the plurality of generated straight lines, and if the number of horizontal bars is less than the preset value, the median strip may be determined to be damaged.

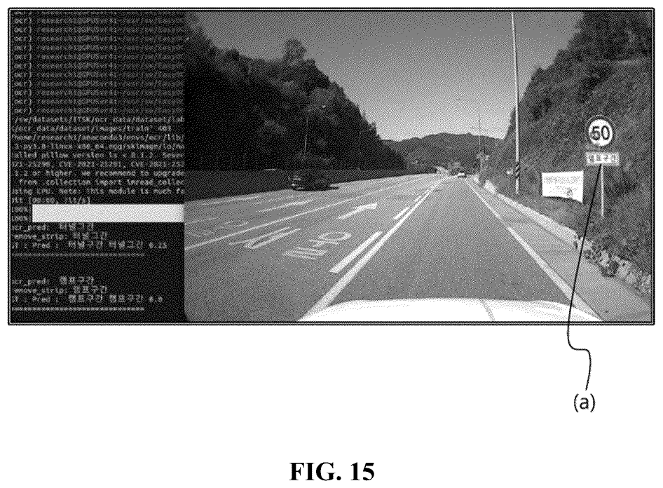

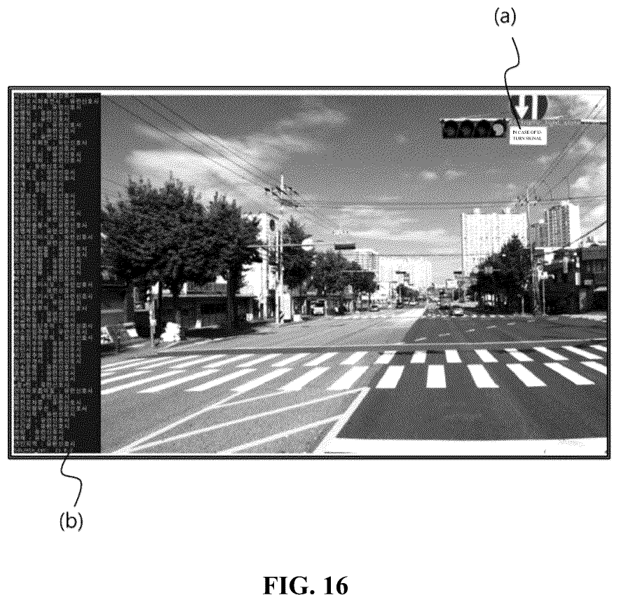

FIGS. 15 and 16 are diagrams illustrating a facility management method according to another embodiment of the present disclosure.

As shown in FIG. 15, the data processing device may detect a facility (a) in the image captured by the camera mounted on the vehicle traveling on the road to set a bounding box, and recognize text written in the set bounding box to identify a type of the facility (a).

In other words, the data processing device may recognize a “ramp section” included in the facility and identify a type of corresponding sign.

At this time, the data processing device may recognize text through optical character recognition (OCR).

Also, as shown in FIG. 16, the data processing device may identify the type of facility corresponding to the identified object based on the text-recognized “in the case of U-turn signal.” That is, the data processing device may identify the type of facility by comparing the recognized text (a) with a pre-stored facility list (b).

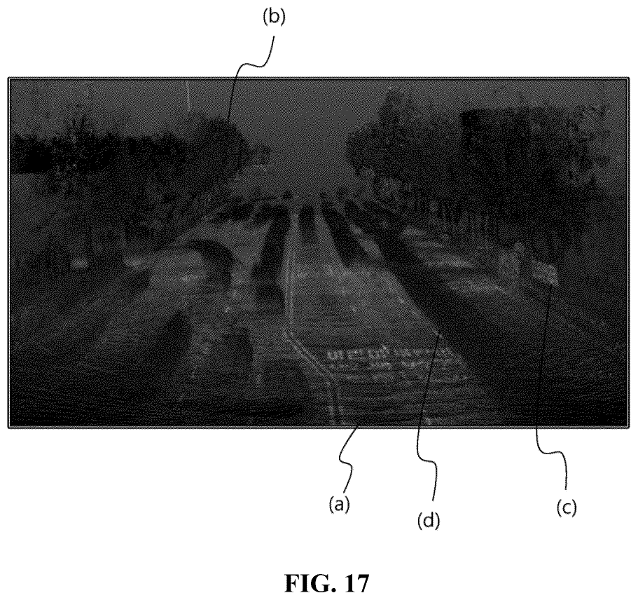

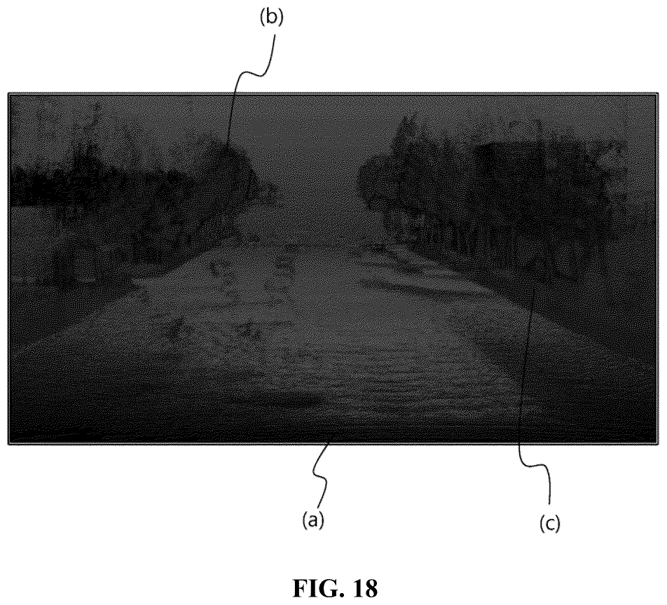

FIGS. 17 and 18 are diagrams illustrating a noise removal method according to an embodiment of the present disclosure.

Specifically, FIG. 17 is a point cloud map generated using point cloud data to which the noise removal method according to an embodiment of the present disclosure is not applied, and FIG. 18 is point cloud map generated using point cloud data to which the noise removal method according to an embodiment of the present disclosure is applied.

As shown in FIG. 17, on the point cloud map, not only static objects, such as a road (a), trees (b), and a facility (c), but also a dynamic object, such as a vehicle (d) are collected. Here, the vehicle (d) corresponds to noise in the precision road map. Therefore, the noise removal method according to an embodiment of the present disclosure may remove noise, such as vehicles on the map.

To this end, the data processing device may identify a preset object from the image, delete the point cloud corresponding to the object identified from the image from the point cloud data, and then generate a map based on the point cloud data from which the point cloud corresponding to the object was deleted.

As described above, embodiments of the present disclosure have been disclosed in the specification and drawings. However, it is self-evident to those skilled in the art to which the present disclosure pertains that other modifications may be made based on the technical concept of the present disclosure, in addition to the embodiments described herein. In addition, various embodiments of the present disclosure have been described using specific terms, but the specification and drawings are to be regarded in an illustrative rather than a restrictive sense in order to help understand the present disclosure. Thus, the foregoing detailed description should not be interpreted limitedly in every aspect and should be considered to be illustrative. The scope of the present disclosure should be determined by reasonable interpretations of the attached claims and every modification within the equivalent range are included in the scope of the present disclosure.

What is claimed is:

1. A noise removal method comprising:
receiving, by a data processing device, point cloud data acquired from a LiDAR and an image captured by a camera;
identifying, by the data processing device, a preset object from the image;
deleting, by the data processing device, a point cloud corresponding to the object identified from the image from the point cloud data; and
generating, by the data processing device, a map based on point cloud data from which the point cloud corresponding to the object was deleted.

2. The noise removal method of claim 1, wherein, in the receiving of the image, whether data of the image previously existed through a dictionary-type compression algorithm is determined to indicate whether the data is repetitive, the image is encoded, and the image is compressed by assigning different prefix codes according to a frequency of appearance of characters included in the image.

3. The noise removal method of claim 1, wherein, in the identifying of the object, a preset object in the image is identified through segmentation based on artificial intelligence (AI) that has been previously machine-trained.

4. The noise removal method of claim 3, wherein, in the identifying of the object, a bounding box is designated in a region corresponding to the preset object in the image.

5. The noise removal method of claim 3, wherein, in the identifying of the object, semantic segmentation is performed on the image based on artificial intelligence that has been machine-trained in advance based on data corresponding to the object.

6. The noise removal method of claim 3, wherein, in the identifying of the object, time stamps for images continuously received by the camera are recorded, the continuously received images are sorted based on the recorded time stamps, and the object is identified based on a similarity between neighboring images among the sorted images.

7. The noise removal method of claim 4, wherein, in the deleting, calibration is performed on the image and the point cloud data, and a point cloud at the same coordinates as the object identified on the image is deleted.

8. The noise removal method of claim 4, wherein,
in the deleting,
at least one object is identified based on a density within the point cloud data acquired from the LiDAR, and a point cloud included in an object in which an amount of change in distance, among the at least one identified object, exceeds a preset value is additionally deleted.

9. The noise removal method of claim 4, wherein,
in the deleting,
the point cloud corresponding to the identified object is deleted on a map pre-generated based on the point cloud data acquired from the LiDAR and the image captured by the camera.

10. A computer program recorded on a recording medium, which is combined with a computing device including a memory, a transceiver, and a processor processing an instruction loaded in the memory to execute
receiving, by the processor, point cloud data acquired from a LiDAR and an image captured by a camera;
identifying, by the processor, a preset object from the image;
deleting, by the processor, a point cloud corresponding to the object identified from the image from the point cloud data; and
generating, by the processor, a map based on point cloud data from which the point cloud corresponding to the object was deleted.
